(19) United States
(12) Patent Application Publication
(10) Pub. No.: US 2023/0036521 A1
(43) Pub. Date: Feb. 2, 2023

(54) IMAGE COMPARISON TO DETERMINE RESOURCE AVAILABILITY

(71) Applicant: INTERNATIONAL BUSINESS MACHINES CORPORATION, ARMONK, NY (US)

(72) Inventors: Aditya Pareek, Jaipur (IN); Gowreeswari Bongu, Hyderabad (IN); Srikanth Adapala, Hyderabad (IN); Chiranjeevi Sutraye, Hyderabad (IN)

(21) Appl. No.: 17/444,060

(22) Filed: Jul. 30, 2021

(51) Int. Cl. G06Q 30/02; G06Q 10/06; G06Q 50/12; H04N 7/18; G06K 9/00

(52) U.S. Cl. CPC G06Q 30/0202; G06Q 10/0631; G06Q 50/12; H04N 7/181; G06K 9/00624; G06N 20/00

(57) ABSTRACT

A method, computer system, and a computer program product for resource management are provided. Respective first images of at least one resource being consumed are captured for each location of a venue. Respective second images of the at least one resource being consumed are captured for each location of the venue. A computer system compares the respective first image to the second image to produce a respective location wait time for each location of the venue. The respective location wait time indicates an estimated duration until the respective location will become vacated and projects that the respective location will become vacated when consumption of the at least one resource at the respective location is finished. The computer system determines a soonest wait time from the location wait times. The soonest wait time is presented.

### BACKGROUND

The present invention relates generally to resource management and to estimating amounts of time a party must wait until a limited location for resource consumption becomes available for use by the party.

### SUMMARY

According to one exemplary embodiment, a computer-implemented method for resource management is provided. Respective first images of at least one resource being consumed are captured for each location of a venue. Respective second images of the at least one resource being consumed are captured for each location of the venue. The respective first image are compared to the second image to produce a respective location wait time for each location of the venue. The respective location wait time indicates an estimated duration until the respective location will become vacated and projects that the respective location will become vacated when consumption of the at least one resource at the respective location is finished. A soonest wait time from the location wait times is determined. The soonest wait time is presented. A computer system and computer program product corresponding to the above method are also disclosed herein.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a resource availability prediction process according to at least one embodiment;

FIG. 3 is a block diagram of internal and external components of computers, phones, and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a method, computer system, and computer program product for resource management of at-capacity venues where prospective consumers will need to wait for placement at the venue until the venue has an opening. In some market situations, more consumers wish to obtain and consume a product than space is available for receiving those consumers at a venue. In such instances, consumers may stand in a queue and may wait until a location at the venue changes from occupied to vacated. A consumer may make a consumption choice based on how long the wait will be until they can enter a vacated spot to consume a resource. The embodiments may help resource providers to better manage expectations of client consumers and to provide improved communication with clients and prospective clients. The embodiments may help client consumers better manage time and attitude as they can receive more accurate predictions about wait times. The present embodiments help improve software for managing resources and for communicating with clients and potential clients.

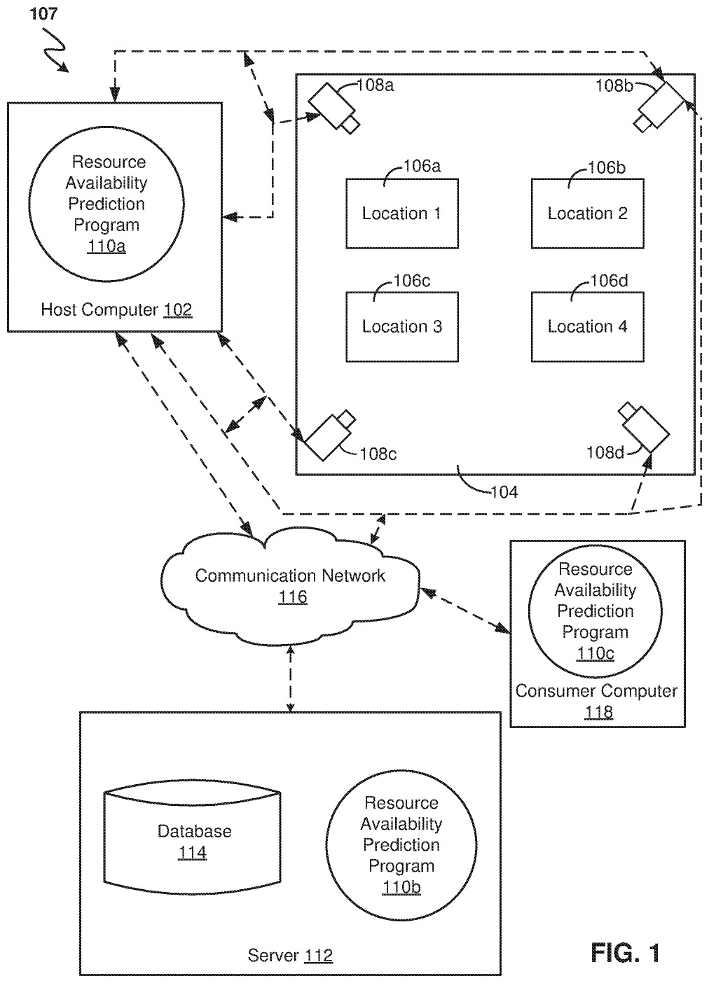

Referring to FIG. 1, a networked computer environment 107 in accordance with one embodiment is depicted. The networked computer environment 107 may include a host computer 102 that is enabled to run resource availability prediction program 110a. The networked computer environment 107 may also include a server 112 that is a computer and that is enabled to run resource availability prediction program 110b that may interact with a database 114. The networked computer environment 107 may also include multiple cameras such as the first, second, third, and fourth cameras 108a, 108b, 108c, 108d that may take pictures of different portions of a venue 104. The networked computer environment 107 may include a consumer computer 118 that is enabled to run resource availability prediction program 110c. The various computers, e.g., the host computer 102, the server 112, and the consumer computer 118, as well as the multiple cameras may communicate with each other via a communication network 116. The networked computer environment 107 may include many computers, many servers, and many cameras, although one host computer 102, one consumer computer 118, four cameras, and one server 112 are shown in FIG. 1. The communication network 116 allowing communication between the host computer 102, the first, second, third, and fourth cameras 108a, 108b, 108c, and 108d, the server 112, and the consumer computer 118 may include various types of communication networks, such as the Internet, a wide area network (WAN), a local area network (LAN), a telecommunication network, a wireless network, a public switched telephone network (PTSN) and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

The host computer 102 may communicate with the server 112, with the first, second, third, and fourth cameras 108a, 108b, 108c, and 108d, and with the consumer computer 102 via the communication network 116. The communication network 116 may include connections, such as wire, wireless communication links, or fiber optic cables. The communication network 116 may itself include multiple servers such as a network edge server and an edge/gateway server which may be enabled to run or assist in operation of the resource availability prediction. The communication network 116 may in some embodiments be or include high speed networks such as 4G and 5G networks. Implementing the present resource availability prediction embodiments in a 5G network will enable at least some embodiments to be implemented on the edge in order to boost network performance.

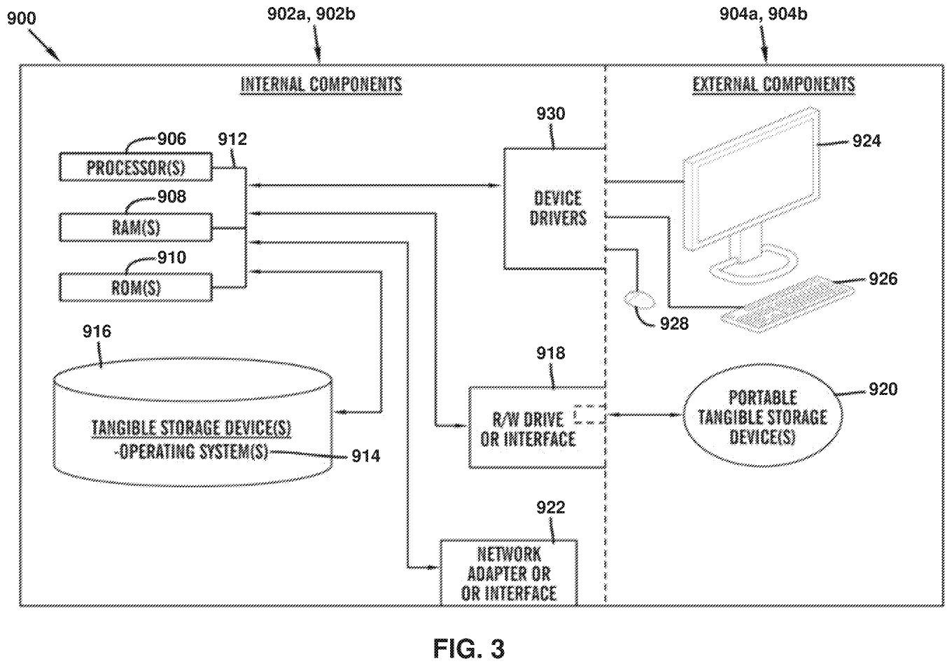

As will be discussed with reference to FIG. 3, the server 112 may include internal components 902a and external components 904a, respectively. The host computer 102 and the consumer computer 118 may also each include internal components 902b and external components 904b as depicted in FIG. 3. Server 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. The host computer 102 and the consumer computer 118 may be, for example, a mobile device, a telephone, a personal digital assistant, a netbook, a laptop computer, a tablet computer, a desktop computer, or any type of computing devices capable of running a program, accessing a network, and accessing a database 114 in a server 112 that is remotely located with respect to the host computer 102 and with respect to the consumer computer 118. The host computer 102 and the consumer computer 118 may include a display screen, a speaker, a microphone, a camera, and a keyboard or other input device. According to various implementations of the present embodiment, the resource availability prediction program 110a, 110b, 110c may interact with a database 114 that may be embedded in various storage devices, such as, but not limited to various computers/mobile devices, a server 112 that may be in a network, or another cloud storage service.

Storing machine learning models on edge servers and/or gateway servers may reduce network traffic that is required for execution of providing and presenting wait time prediction and next-available-location predictions described herein. This reduction in network traffic may help achieve efficient processing for execution of the methods according to the present embodiments. A person operating the host computer 102 and another person seeking to obtain a wait time, e.g., via the consumer computer 118, may utilize network infrastructure to gain appropriate connectivity, e.g., 5G connectivity, into the environment. The present embodiments may take advantage of existing and future 5G infrastructure and its increase of bandwidth, latency, and scaling of applications requiring large amounts of real-time data. The server 112 may trigger data and command flows to be processed by distributed enhanced experience capability programs that are available at a network edge server located at a network edge and/or that are available at an edge/gateway server located at a network gateway. The server 112 may be an edge server or a gateway server.

A user/consumer in a vicinity of a resource-providing venue and a resource-consumption venue, e.g., venue 104, may use the consumer computer 118 to obtain a wait time and a next-location-to-be-available prediction that may be generated using some or all of the first, second, third, and fourth cameras 108a, 108b, 108c, and 108d, the host computer 102, and the server 112 and that may be transmitted to the consumer computer 118 via the communication network 116. The wait time and/or the next-location-to-be-available prediction may be displayed on a display screen of the consumer computer 118 and/or be played audibly via a speaker of the consumer computer 118 so that this information is able to be seen and/or heard by the user.

A computer system with the resource availability prediction program 110a, 110b, 110c operates as a special purpose computer system in which the resource availability prediction process 200 assists in the determination of an estimated time until a space becomes vacated by a resource consumer. In particular, the resource availability prediction program 110a, 110b, 110c transforms a computer system into a special purpose computer system as compared to currently available general computer systems that do not have the resource availability prediction program 110a, 110b, 110c.

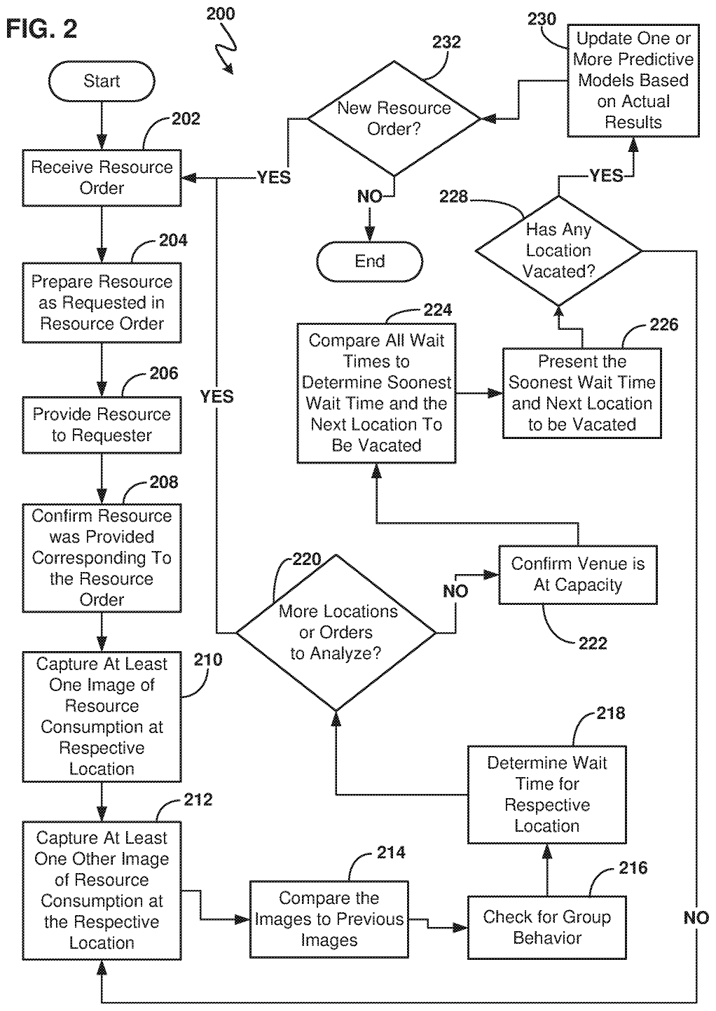

Referring now to FIG. 2, an operational flowchart depicts a resource availability prediction process 200 that may, according to at least one embodiment, be performed using the resource availability prediction program 110a, 110b, 110c. The resource availability prediction program 110a, 110b, 110c may include various modules, user interfaces, and services and may use data storage when the resource availability prediction process 200 is performed.

In a step 202 of the resource availability prediction process 200, a resource order is received. The resource order may request one or more resources from a resource provider. The resource provider may exchange resources for money with the party who requested the resource order. The resource provider may provide the resources at a venue 104.

The receiving of step 202 may occur with a party/requester placing the request in person at the venue 104. The request may be made to a person working at the venue 104 for the resource provider. The requester may verbally give an order to such worker and such worker may input the resource order into a computer system associated with the venue 104. For example, a worker may input the received order into an input device associated with the host computer 102. This inputting may encompass the worker speaking into a microphone connected to the host computer 102, typing into a keyboard connected to the host computer 102, and/or touching a touch screen graphical user interface connected to the host computer 102 in order to input the received order. In other embodiments a party/requester may input an order into a touch screen of some computer or ordering kiosk at the venue 104 that has a connection, e.g., via the communication network 116 or via an intranet connection, to the host computer 102.

The receiving of step 202 may also occur in response to a user placing a request that is transmitted across the communication network 116. A user may use software on the consumer computer 118, e.g., may use a resource provider app or an interactive website of the resource provider, to choose a resource and send that resource order to the resource provider. The resource provider may receive this resource order at the host computer 102 as a consequence of the host computer 102 being connected to the communication network 116.

In an example where the resource provider is a cafeteria, restaurant, café, bar, eatery, coffee shop, food court, food truck, etc., the resource order may be a request for one or more food and/or drink items to be prepared by the resource provider. The one or more food/drink items may include cooked food, dessert food, beverages, grown food, food/beverage mixtures, etc. A food item in this disclosure encompasses drink items and food-drink mixtures. In this example, the venue 104 may be the cafeteria, restaurant, café, bar, eatery, coffee shop, food court, food truck with eating tables, etc. Each of the first, second, third, and fourth locations 106a, 106b, 106c, and 106d may be a different table at the venue 104. Multiple chairs may surround each table to allow resource consumers to sit and eat, while the table or counter holds the food item they ordered and received.

The step 202 may also include capturing an image of the party/requester who placed the resource order. One or more cameras, e.g., one or more of the first, second, third, and fourth cameras 108a, 108b, 108c, 108d, may capture the image of a consumer who placed an order in an ordering area. This image of the consumer placing the order may be referred to as a requester image and may be used subsequently in the resource availability prediction process 200. This image may capture visual information about the clothing that is being worn by the consumer who places the order, so that the resource availability prediction program 110a, 110b may be better able to identify where in the venue 104 that particular consumer sits or stands to consume the resource received.

In a step 204, the resource is prepared as requested in the resource order. The resource order may be that resource order that was received in step 202. One or more workers for the resource provider may use one or more tools to affect one or more elements, ingredients, pieces, etc. to prepare the resource according to the resource order.

Continuing the above example in which the resource that is ordered is a food item, the resource provider may cook and/or prepare food ingredients to perform step 204. This preparation may occur in a specific location of the venue 104, e.g., in a kitchen area of the venue.

In a step 206, the resource is provided to the requester. This resource that is provided in step 206 may be the resource that was prepared in step 204 and that was ordered in step 202. This providing may take place at the venue 104.

In some embodiments, the providing of the resource in step 206 may occur while the receiving consumer is already at the specific location of the venue 104. This specific location may, for example, be the first, second, third, or fourth location 106a, 106b, 106c, 106d that is shown in FIG. 1. A worker of the resource provider may deliver the prepared resource from a preparation location to the specific location. These specific locations in some embodiments may be tables with chairs, booths with table/chair combinations, etc.

In some embodiments, a user may proceed to a specific location of the venue 104 after receiving the resource in step 206. This specific location may, for example, be the first, second, third, or fourth location 106a, 106b, 106c, 106d that is shown in FIG. 1. These specific locations in some embodiments may be tables with chairs, booths with table/chair combinations, etc.

Continuing the above example in which the resource that is ordered is a food item, step 206 in this example may include a worker of the resource provider handing the food item to the consumer somewhere at the venue 104. The worker may provide the food item to the consumer in an ordering area or may serve the food item to the consumer who has already taken a place at one of the tables, booths, etc. of the venue 104, e.g., has already taken place at the first location 106a.

In a step 208, whether the resource was provided corresponding to the resource order is confirmed. This step may confirm whether the resource that was provided in step 206 matches the resource order that was received in step 202. Step 208 may include one or more cameras such as the first, second, third, or fourth camera 108a, 108b, 108c, or 108d taking a picture of the consumer and of the immediate surroundings of the respective consumer. The image of this picture may be referred to as a confirmation image. Within the immediate surroundings shown in that captured image may be a received resource that was provided in step 206. The resource order that was received in step 202 may be saved in data storage of the host computer 102 or that is accessible to the host computer 102, and this data may be compared with information from the confirmation image that is captured by one or more cameras.

The resource availability prediction program 110a, 110b may include one or more image-identifying machine learning models in which images of received resources are input into the machine learning model and the machine learning model as an output provides names or titles of the resources in the image. A resource provider may provide many different resources at a venue 104. The machine learning model may be trained with images of the different resources, so that when a new confirmation image is captured and received and input into an image-identifying machine learning model the image-identifying machine learning model may indicate which resource is shown in the photo. This output may be provided as text that includes the name of the identified resource.

A comparison module of the resource availability prediction program 110a, 110b may compare the text output of the image-identifying machine learning model with text from the resource order received in step 202 in order to confirm in step 208 whether the full order has been provided in step 206.

The confirmation of step 208 may enable the avoidance of false positives that might occur when the resource availability prediction program 110a, 110b, 110c identifies that a round of resource consumption has finished but this identification misinterpreted image information. The misidentification may be caused by a confirmation image showing no resources by a consumer or showing small amounts of resources by a consumer in the venue 104. A consumer being in the venue 104 at a particular location, e.g., at the first, second, third, or fourth location 106a, 106b, 106c, 106d, may have no consumable resource, as indicated in an image captured by one of the cameras, due to not yet having received the resource from the resource order that was placed and received in step 202. The consumer may have small amounts of consumable resource, as indicated in an image captured by one of the cameras, due to having received a partial amount of the resource from the resource order that was placed and received in step 202 and not yet having received the resource corresponding to the entire order. Thus, the confirmation of step 208 helps avoid false positives.

If an image is taken of a resource in the venue 104, the resource availability prediction program 110a, 110b, 110c may scour through and compare with all recently received orders to help identify which order or orders best match or potentially match a served or partially-served order. Recently received orders may include all orders received within a particular threshold time limit. For example, a recently received order may include any order that was received within the past thirty minutes. The particular threshold time limit may depend on typical resource preparation times for a particular resource provider. For example, the particular threshold time limit may be longer for those resource providers who take a longer time to prepare resources. The particular threshold time limit may be shorter for those resource providers who take a shorter time to prepare resources. The recently received orders may be saved within a data storage of or accessible to the resource availability prediction program 110a, 110b, 110c.

The confirmation of step 208 may also include comparing images of a respective consumer to help obtain a proper match of the consumer who placed the order that was received in step 202 and the consumer who is receiving a resource in step 206. Thus, confirmation images that were described above may include images of the consumer in addition to images of the received resources. Recognizing where a consumer who placed an order has taken a place in the venue 104 may help the resource availability prediction program 110a, 110b, 110c to better match resource provision, e.g., the provision of step 206, with orders that are placed, e.g., that resource order that was received in step 202. In some embodiments, a comparison module may compare clothing of a consumer from a requester image with clothing of a consumer from the confirmation image in order to find the correct resource order. A consumer who placed an order in person at the venue 104 will typically be wearing some, most, or all of the same clothing when the ordered resource is provided to the consumer at the venue 104, whether the ordered resource is provided to the consumer at a particular location within the venue 104 or if the consumer receives the resource and then proceeds to a particular location at which the confirmation image is captured.

Step 208 may include a combination of both recent order comparison and consumer image comparison as explained above to help match confirmation images taken with orders received.

Continuing the above example in which the resource that is ordered is a food item, in this example step 208 may include the first camera 108a taking a picture of a consumer at the first location 106a who has received three food items corresponding to three items which were part of the resource order that was received in step 202. If the confirmation image were to show that one of the food items was received but not the second and third food items that were also requested, the resource availability prediction program 110a, 110b may recognize that the meal is at a beginning stage and not near an end stage. The lack of provisioning of the full order may be evidence of the meal being at an early point instead of at a point nearer to the meal end after which the particular location may be vacated by the one or more consumers. In the example, the requester was wearing a blue striped shirt at the time of order placement associated with step 202, and the confirmation image may identify the person wearing a blue striped shirt in the confirmation image(s) in order to match the requester and the received order. The resource availability prediction program 110a, 110b may delay further steps of the resource availability prediction process 200 for this consumer, until the confirmation images confirm that the entire order, e.g., all three requested food items, has been received by the requester. The resource availability prediction program 110a, 110b may capture repeated confirmation images until a confirmation of full order provision is received.

In a step 210, at least one image of resource consumption is captured at the respective location. This image may be taken by one or more cameras at the venue 104, e.g., by one or more of the first, second, third, and fourth cameras 108a, 108b, 108c, 108d. This at least one image may be referred to as a first image or a first consumption image or may include a first image or a first consumption image. The various cameras of the venue 104 may each be positioned to cover a particular area of the venue 104. For example, the first, second, third, and fourth cameras 108a, 108b, 108c, and 108d may each be positioned to capture images of the first, second, third, and fourth locations 106a, 106b, 106c, and 106d, respectively. Alternatively, multiple cameras may work together to capture images of a particular location so that step 210 may include combining the information from multiple images taken from multiple angles to better obtain information about the current usage and resource consumption of a particular location including the number of consumers at the particular location, the capacity of the particular location, e.g., the number of consumers for which the particular location was designed to be able to hold at a single time, and the current amount of resource that is at the particular location. Step 212 may focus on images of resources at the particular location in order to track resource consumption rates. The cameras chosen for the image capture of step 210 may be those best positioned to view the resource resting area of a particular location. Step 212 may also include capturing of the images of requesters at the particular location, as requester images may reveal information about any groups that are consuming together and which may be used in another step of the resource availability prediction process 200.

The resource availability prediction program 110a, 110b may include an image-based consumption machine learning model which takes various images of partially consumed resources as input and compares these images with images of newly provided unconsumed resources to indicate how much of the resource has been consumed. This image-based consumption machine learning model may be trained with supervised learning and may be updated through various iterations of performance of the resource availability prediction process 200 as will subsequently be explained with respect to step 230 of the resource availability prediction process 200.

For the continued example of the resource being a food item, the step 210 may include one or more of the first, second, third, and fourth cameras 108a, 108b, 108c, 108d taking a picture of the first location 106a which may include a table that is holding the three food items that were ordered. The particular one or more cameras that are used will be those that are positioned to capture a clear view of the table of the first location 106a, e.g., the first camera 108a may be used to capture the image. This first consumption image that is taken may show that half of each of the three ordered-and-provided food items have been consumed.

In a step 212, at least one other image of resource consumption at the respective location is captured. This image may be taken by one or more cameras at the venue 104, e.g., by one or more of the first, second, third, and fourth cameras 108a, 108b, 108c, 108d. This at least one image may be referred to as a second image or a second consumption image or may include a second image or a second consumption image. This at least one other image may be taken at a second time after a first time at which the at least one first image was captured in step 210. As with the at least one first image, information from a single image from a single camera or from multiple images taken from different cameras with different angled views of a particular location may be used together to gather information about a consumption stage, level, or rate of resource consumption at that particular location.

For the continued example of the resource being a food item, the step 212 may include one or more of the first, second, third, and fourth cameras 108a, 108b, 108c, 108d taking a picture of the first location 106a which may include a table that is holding the three food items that were ordered. The particular one or more cameras that are used will be those that are positioned to capture a clear view of the table of the first location 106a, e.g., the first camera 108a may be used to capture this second image. This second consumption image that is taken may show that one of the three ordered-and-provided food items is gone and that the other two are ninety percent consumed. The absence of the first food item in the one or more second images may be interpreted by the image-based consumption machine learning model of the resource availability prediction program 110a, 110b as this first food item having been completely consumed, especially in comparison to the one or more first consumption images from step 210 which showed the presence of that particular first food item.

In a step 214, the images are compared to previous images. These images may include the at least one other image that was captured in step 212 and the previous images may include the at least one image that was captured in step 210. This comparison of step 214 may be performed by an image-based consumption machine learning model. This comparison of step 214 may also include a comparison of the new images captured in steps 210 and 212 to historical images of partially-consumed resources that have been saved within the image-based consumption machine learning model.

This comparison of step 214 may further include inputting a time duration that ran between the capturing of the at least one first image in step 210 and the at least one other image in step 212. With this time duration input, a resource consumption rate may be determined and then used to calculate a projected time until all of the resources in this particular order will be consumed at that particular location. Additional time durations such as a time duration from an initial confirmation of all ordered resources having been received (step 208) until the present time may also be input as part of step 214 to help determine a resource consumption rate.

This comparison of step 214 may also or alternatively include a comparison of image data that was determined based on the images from the steps 210 and 212. For example, if the first images (captured in step 210) indicated that the ordered resources were fifty percent consumed and the other images (captured in step 212) indicated that at the later timepoint ninety percent of the resources were consumed, the image data of fifty percent and ninety percent may be compared to each other by the machine learning model of the resource availability prediction program 110a, 110b in order to determine a resource consumption rate.

In a step 216, a check for group behavior is made. This check may include inputting some or all of the captured information into a group recognition machine learning model that may be part of the resource availability prediction program 110a, 110b. The captured information may include the resource order that was received in step 202 including any requester image that was captured, the confirmation (step 208) of the provision of the prepared resource that occurred in step 206 including any confirmation image that was captured, the at least one image that was captured in step 210, and the at least one other image that was captured in step 212. The group recognition machine learning model may be separate and different from possible image-identifying machine learning models that are part of the resource availability prediction program 110a, 110b and that were explained previously. The group recognition machine learning model may also be separate and different from any image-based consumption machine learning model that is part of the resource availability prediction program 110a, 110b and that are subsequently explained with respect to steps 214, 220, and/or 222.

The group recognition machine learning model may check the resource order that was received in step 202 to determine whether the amount and types of resources that were ordered reflect an order for a single consumer or for multiple consumers. Continuing the food item example, an order that includes a single main dish may be evidence of a single requester, but an order with multiple main dishes may be evidence of the order being for a group of consumers.

Moreover, the group recognition machine learning model may check input images such as a requester image, the confirmation image, the first consumption image(s), and the second consumption image(s) to look for any indication of interaction between multiple consumers who are within the view of the image(s). Such interaction may be evidence of the presence of a group. Such interaction indications may include positioning of the consumers. For example, if a body position of a first consumer is positioned to face a neighboring consumer in one or more of the images while the neighboring consumer is speaking, the machine learning model may interpret this body positioning as group behavior, because the first consumer may be closely listening to the neighboring consumer.

Overall images of an entire particular location such as the first location 106a, which may be a first table, may be input as a part of step 216 into the group recognition machine learning model to identify patterns for empty places at the location. When one consumer finishes their resources and then that place at the particular location becomes vacated in the subsequent images and the vacated spot remains for a time duration longer than a threshold time period, the group recognition machine learning model may interpret this information as indicating that the consumer at that spot at the location has finished his resource consumption at this venue 104 and has vacated that spot at the location, e.g., at the table. If a location place is vacated for a time period that is less than a threshold time period, an assumption may be made by the resource availability prediction program 110a, 110b that the spot is not yet vacated but is temporarily vacated due to some other reason not caused by finishing of consumption. For example, the vacated spot may have been temporarily vacated by the consumer due to use of a restroom at or near the venue 104, to obtaining a napkin or other resource consumption aid, to leaving a table for more privacy for making or receiving a phone call, etc.

The check for group behavior of step 216 may also include the receipt of any reservation information that a requester gave to the resource provider. Such reservation information may have been received in advance of the resource consumers coming to the venue 104 or may have been received when the consumers placed a resource order that was received in step 202. When a set of reservation information is input which indicates that the reservation is for a group, e.g., for a number of consumers greater than one, then the group recognition machine learning model may be bypassed, because a confirmation is already received that a group came together and will be consuming resources together. In this embodiment where the reservation information revealed presence of a group, image inputs may be still be taken and/or used for step 216 in order to determine which places and which particular location or locations at the venue 104 the group occupies during their resource consumption and in some instances while waiting for provision of the ordered resources. This placement information for a group may be used by the wait time and next-location-to-be-vacated machine learning model which will be described subsequently.

An output of step 216 may be a determination whether a group is together at one of the locations at the venue 104, e.g., the first location 106a. Step 216 may include receiving the output of the group recognition machine learning model. The resource availability prediction program 110a may receive via the communication network 116 a transmitted determination from a group recognition machine learning model which may be stored in the cloud, e.g., in the server 112. Step 216 may also or alternatively include receipt of reservation or order information which indicates that the consumers are consuming as a group. In this instance, the group recognition machine learning model may be bypassed as the presence of the group is confirmed via the reservation.

In step 218 of the resource availability prediction process 200, the wait time for the respective location is determined. This determination may include using a resource consumption rate and may include considering the presence of any group that was recognized in step 216 as being at that particular location. The wait time may refer to the amount of time from the present until the particular location will become vacated and be open to be able to be newly occupied by a new receiver of resources. An output of the image-based machine learning model that was generated from image comparison for this particular location or consumption position may be used to determine the wait time. The input for the determinations of step 218 may also include comparisons of image data. A wait time machine learning model may be used to determine the wait time of step 218, where one or more of the above-mentioned inputs are input into the wait time machine learning model and the wait time machine learning model outputs an estimated wait time for the particular location or occupying position of the venue 104.

Any group identified in step 216 affects the determinations of step 218 in that for each consumption-occupying spot that is currently occupied by a group, each of those spots will be considered to have its respective wait time to be equal to the longest estimated wait time that was determined for any of the consumption-occupying spots within that group. For example, with a group of four consumers whose estimated wait times until consumption finishing are five minutes, seven minutes, nine minutes, and eleven minutes, respectively, for the determinations of step 218 each of those spots will be considered to have a wait time of eleven minutes. This use of the slowest time for each spot in the group is performed based on an assumption that the consumers finishing earlier will wait and not leave until the slowest-consuming consumer in their group is finished, e.g., after eleven minutes.

If no group was recognized in step 216 for this particular location, then the wait time for this particular location or consumption spot may be based on the image data compared at this location without any adjustment for consumption done by other consumers in neighboring positions. For example, with four consumers disposed next to each other at the first location 106a and wait times until consumption finishing being five minutes, seven minutes, nine minutes, and eleven minutes for these four consumers, for the determinations of step 218 those four spots will be considered to have a respective wait time of five minutes, seven minutes, nine minutes, and eleven minutes. It will be assumed that each consumer will leave after their finishing of consumption regardless of a longer or shorter consumption time for a neighboring consumer.

For the wait time determination and resource consumption analysis, the rate of consumption for individual resources of a set of resources being consumed may be weighted according to an importance of the respective resource. A consumption rate of a first resource may be given a first weight that is greater than a second weight given to a consumption rate for a second resource. For example, in a food setting the consumption rate of a main dish, e.g., a hamburger, may be weighted to have higher relevance in the wait time determination than the consumption rate of a side dish, e.g., fries, has. If the main dish is mostly consumed, e.g., ninety percent consumed, as indicated by the image comparisons, and the side dish is half consumed, as also indicated by the image comparisons, the wait time determined may be chosen as sooner rather than later because the resource availability prediction program 110a, 110b may assume that the consumer gives less consideration for a side dish and will have less motivation to consume the entire side dish as compared to the desire to consume the entire main dish.

Venue-specific weights may also be given regarding cultural norms whether it is customary for consumers to finish all of their resources. In some cultures, it may be more common for users to finish and vacate without finishing each of multiple received resources. For example in a food setting, it may be more customary for consumers to vacate without finishing each food item, especially without finishing each side dish.

Continuing the specific example where a consumer received three food items and had finished one of the three food items ninety percent and had finished the other two food items at ninety percent and had been eating for twenty minutes, the resource availability prediction program 110a, 110b may determine a wait time of five minutes until the consumer will vacate the seat that he or she currently occupies at the first location 106a of the venue 104. This wait time determination was based on a finding in step 216 of no group behavior for this consumer. The wait time determination assessed that the main dish already ninety percent finished would take three more minutes until entire consumption. This main dish determination was based on a main dish consumption rate of about one main dish consumed per 22.22 minutes using input of needing twenty minutes to consume ninety percent of the main dish. The wait time determination also assessed that the second and third food items which are side dishes will not be eaten to completion but that the consumer may take an additional two minutes after main dish completion before vacating the occupying position at the first location 106a of the venue 104.

In step 220 of the resource availability prediction process 200, a determination is made whether there are more locations or orders to analyze. If the determination of step 220 is affirmative that there are more locations or orders to analyze, the resource availability prediction process 200 returns to step 202 for a repeat of steps 202, 204, 206, 208, 210, 212, 214, 216, and 218 for the further location or for the further order. If the determination of step 220 is negative that there are not more locations or orders to analyze, the resource availability prediction process 200 proceeds to step 222. To perform step 220, the resource availability prediction program 110a, 110b may check a queue in memory of or accessible to the resource availability prediction program 110a, 110b to identify if any outstanding orders or locations of the venue 104 have not been analyzed for resource consumption progress. The resource availability prediction program 110a, 110b may place an indication in the queue if any new resource is received or may place a marker for each location or consumption spot in the venue 104. The resource availability prediction program 110a, 110b may check whether a current wait time has been determined for each of the locations or consumption spots of the venue 104.

In step 222 of the resource availability prediction process 200, a confirmation is made that the venue 104 is at capacity. This confirmation may include capturing and analyzing one or more images captured by cameras at the venue 104 to identify if any particular locations or consumption positions at the venue 104 are unoccupied. If the venue is not at capacity and one or more locations or unoccupied spots are available for a new consumer, then the wait time may be zero as the new consumer can immediately take a seat or take a place. This confirmation may also be done with respect to particular group sizes that may arrive. If the check indicates that five individual spots are open but spread throughout the venue 104, then the venue 104 may be considered to be at capacity for any group greater than one but not to be at capacity for individual consumers who arrive. The individual consumers could immediately take place at one of the five open spots spread throughout the venue 104. However, there is no suitable place for a group of two or more to take seats or places. Thus, the capacity check may be made with respect to particular group sizes. When every seat of the venue 104 is filled, then the venue 104 is at capacity for groups and also for individual consumers, as all newcomers will have to wait for an open spot to become available.

When a confirmation is made so that the venue 104 is at capacity, then the wait time analysis is relevant and the resource availability prediction process 200 proceeds to step 224. If the venue is not at capacity, the individual location wait time and food images may be stored for such time that the venue 104 reaches capacity. Then at that point the resource availability prediction process 200 may proceed to step 224.

In step 224 of the resource availability prediction process 200, all wait times are compared to determine the soonest wait time and the next location to be vacated. The step 224 may include scouring the results of each wait time determination for step 218 regarding each consumption occupying position in the venue 104 or for each particular location in the venue 104, and then comparing those projected wait times which project how long until the respective consumers finish their consumption at each position or location and then vacate the position or location. Amongst all of the wait times for the occupying positions or locations, the soonest projected time may be selected by the resource availability prediction program 110a, 110b. The resource availability prediction program 110a, 110b may include a comparison tool which scours and compares each determined and saved wait time for a specific consumption spot to find the smallest wait time.

The next location to be vacated may refer to a consumption area with multiple places, to any individual consumption position within the venue, or to a set of contiguous consumption positions being vacated whose amount matches the amount of a person or group seeking to occupy positions for the sake of consumption. For example, for a single person wishing to have any seat at any of multiple tables, the next location to be vacated determination may indicate which of any of the seats at any of the tables at the venue 104 will next become vacated. The next location to be vacated determination may alternatively indicate when an entire table or booth at the venue 104 has become vacated. For a group with four people waiting to occupy positions, the next location to be vacated determination may indicate when any four contiguous positions at tables within the venue 104 have become vacated or when an entire booth or table with at least four consumption positions has become vacated.

In instances where a party seeking to newly occupy a consumption position is not first in a waiting queue, the determinations of step 224 may include accounting for people ahead in the queue needing to find an open consumption spot before the particular party will have an open consumption spot. For example, if a party is fourth in the queue then the fourth soonest wait time amongst the various consumption positions is selected and that wait time is presented to this particular party as the correct estimated wait time. However, for the parties who are first, second, or third in the queue the determined wait times may be shorter than the determined estimated wait time for the potential consumer who is fourth in the queue.

In step 226, the soonest wait time and the next location to be vacated are presented. This presentation may be to an organizer of the venue 104 or directly to a potential consumer. For example, the presentations may be to an organizer of the venue 104 by being displayed on a display monitor 924 of the host computer 102. The organizer may then verbally or pictorially inform potential consumers of the estimated wait time and the estimated next location to be vacated. The presentations may be made on a large display screen at the venue 104 so that potential consumers in a waiting area near the venue 104 may easily visibly or audibly ascertain what the wait time is, which will help them have patience for a wait and also to decide if they would like to wait. In addition or alternatively, the presentations may be made directly to a potential consumer by being displayed on a display monitor 924 or display screen of the consumer computer 118, e.g., a mobile phone of the consumer. Such presentations may also occur audibly by being played over a speaker connected to the host computer 102 and/or to the consumer computer 102. The resource availability prediction program 110c on the consumer computer 118 may receive the determination data via a transmission through the communication network 116 and may then process that determination data in order to produce the presentation, e.g., via the screen, monitor and/or speaker of the consumer computer 118.

In step 228, a determination is made whether any location has vacated. This determination may be made by capturing images of the venue 104 and identifying consumers finishing their consumption and then leaving the venue 104. When images are compared, comparison of clothing information from the previous images may match consumers leaving the venue 104 and the occupying position/spot they used in the venue 104. The determination of step 228 may additionally or alternatively be made by workers of the venue 104 manually confirming the vacating of certain spots by inputting information into a graphical user interface displayed at the host computer 102, e.g., into an interface showing a map of the venue 104 and showing each location and occupying position within the venue 104.

If the determination is negative and no location has vacated, then the resource availability prediction process 200 may return to step 212 for a repeat of steps 212, 214, 216, 218, 220, 222, 224, and 226. As part of the repeats of these steps, new images for previous locations may be taken to compare to earlier images that were taken. This further comparison may generate information which may be used to update resource consumption rates and/or individual wait times for each location. As the wait times and next-vacated-location determinations are estimates based on data, the estimates may become more accurate with more data points to analyze. Thus, repeating some or all of the above-mentioned steps while the waiting is occurring may help the resource availability prediction program refine and improve its predictions.

If the determination for step 228 is positive, then the resource availability prediction process 200 may proceed to step 228.

In step 230, one or more predictive models are updated based on the actual results. The models that may be updated may include an image-identifying consumption machine learning model, an image-based consumption machine learning model, a group recognition machine learning model, and a wait time machine learning model. The actual results may come from the vacating of locations or occupying positions determined in step 228 and from comparisons whether wait times that were generated and presented matched actual wait times that ended when the location or occupying position became available. By updating the machine learning models, the machine learning models may become improved during their continual use during operation of the resource provision at the venue 104 when the venue 104 is at capacity. The image-identifying machine learning model may be updated to reflect whether its resource identification matched which resource was indeed provided to a consumer. The image-based consumption machine learning model and the wait time machine learning model may be updated to reflect whether their determined resource consumption rates and wait times matched the actual resource consumption rates and the actual wait times. The group recognition machine learning model may be updated to reflect whether it correctly analyzed whether a group was consuming together at the venue 104. This update may include information that multiple consumers vacated contiguous positions at the venue 104 at approximately the same time.

In step 232, a determination is made whether a new resource order has been made. The resource availability prediction program 110a, 110b may ascertain whether any new internet order has been received or whether a worker or consumer has manually input any new resource order into an input device at the venue 104.

If the determination for step 232 is positive, the resource availability prediction process 200 may return to step 202 for a repeat of the resource availability prediction process 200 with respect to the new order.

If the determination for step 230 is negative, the resource availability prediction process 200 may end. Such an ending may occur near a closing time for a venue 104, as after a closing time no new consumers may be accepted for resource consumption until a following time period, e.g., until the next day.

With the present embodiments, the resource availability prediction program 110a, 110b, 110c intelligently identifies which location, e.g., table, is next going to be empty, while respecting privacy of the consumers. The present embodiments find and determine the next empty location in a venue through intelligent processing of images, order details, and identification of groups. The time of serving the order and the historic amount of time to finish the order may be included as input into the determination of how much time is required for a party to finish their consuming. This resource management may be used in a full cafeteria or restaurant to help determine the next table or seat to be vacated and an estimated time until the table or seat is vacated. Multiple tables or sitting spots may be included in the determination and analyzed, with images being captured of all tables at the venue to determine which table will first have an open spot. The wait time may also consider a queue position of a prospective consumer, so that the wait time may include the time for persons closer in the queue who will take vacated spots before the respective user can take a vacated spot.

Resource availability data that is generated during the resource availability prediction process 200 may be stored in memory that is part of the resource availability prediction program 110a, 110b, 110c or that is accessible to the resource availability prediction program 110a, 110b, 110c. For example, individual seat wait times may be saved in the database 114 shown in FIG. 1, in the RAM 908 that is shown in FIG. 3, in memory of a server within and connected to the communication network 116, and/or in other memory in one or more remote servers that is accessible to the resource availability prediction program 110a, 110b, 110c via the communication network 116 and/or via a wired connection.

It may be appreciated that FIG. 2 provides an illustration of an embodiment and does not imply any limitations with regard to how different embodiments may be implemented. Many modifications to the depicted embodiment(s), e.g., to a depicted sequence of steps, may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902a, 902b, 904a, 904b is representative of any electronic device capable of executing machine-readable program instructions. Data processing system 902a, 902b, 904a, 904b may be representative of a smart phone, a computer system, PDA, or other electronic devices. Examples of computing systems, environments, and/or configurations that may represented by data processing system 902a, 902b, 904a, 904b include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Host computer 102, first, second, and third receiver computers 104a, 104b, and 104c, and server 112 may include respective sets of internal components 902a, 902b and external components 904a, 904b illustrated in FIG. 3. Each of the sets of internal components 902a, 902b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914 and the resource availability prediction program 110a in computer 102, and the resource availability prediction program 110c in server 112 may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory, or any other computer-readable tangible storage device that can store a computer program and digital information.

Each set of internal components 902a, 902b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the resource availability prediction program 110a, can be stored on one or more of the respective portable computer-readable tangible storage devices 920, read via the respective R/W drive or interface 918 and loaded into the respective hard drive, e.g., the tangible storage device 916.

Each set of internal components 902a, 902b may also include network adapters (or switch port cards) or interfaces 922 such as a TCP/IP adapter cards, wireless wi-fi interface cards, or 3G, 4G, or 5G wireless interface cards or other wired or wireless communication links. The resource availability prediction program 110a in computer 102 and the resource availability prediction program 110b in the server 112 can be downloaded from an external computer (e.g., server) via a network (for example, the Internet, a local area network or other, wide area network) and respective network adapters or interfaces 922. From the network adapters (or switch port adaptors) or interfaces 922, the resource availability prediction program 110a in computer 102 and the resource availability prediction program 110b in server 112 are loaded into the respective hard drive, e.g., the tangible storage device 916. The network may include copper wires, optical fibers, wireless transmission, routers, firewalls, switches, gateway computers and/or edge servers.

Each of the sets of external components 904a, 904b can include a computer display monitor 924, a keyboard 926, and a computer mouse 928. External components 904a, 904b can also include touch screens, virtual keyboards, touch pads, pointing devices, and other human interface devices. Each of the sets of internal components 902a, 902b also includes device drivers 930 to interface to computer display monitor 924, keyboard 926 and computer mouse 928. The device drivers 930, R/W drive or interface 918 and network adapter or interface 922 include hardware and software (stored in storage device 916 and/or ROM 910).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

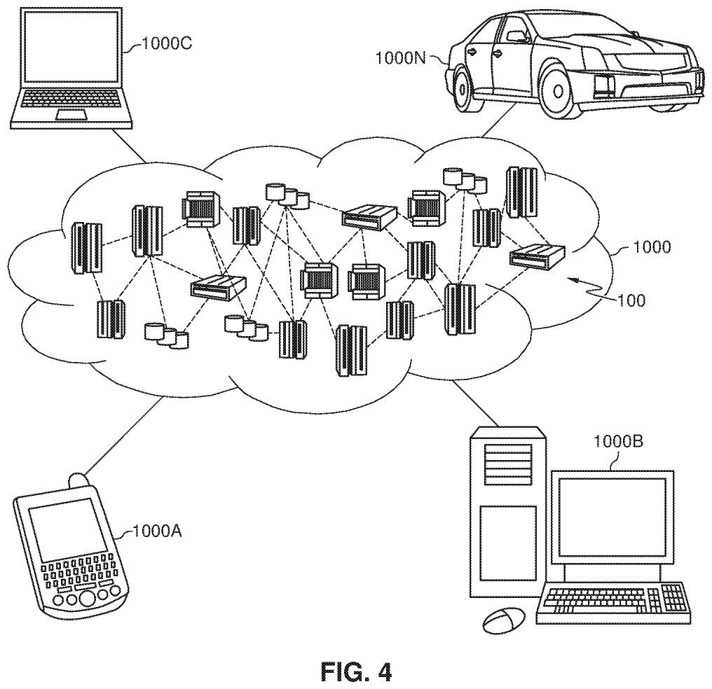

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1900 can communicate with any type of computerized device over any type of network and/or network addressable connection (e.g., using a web browser).

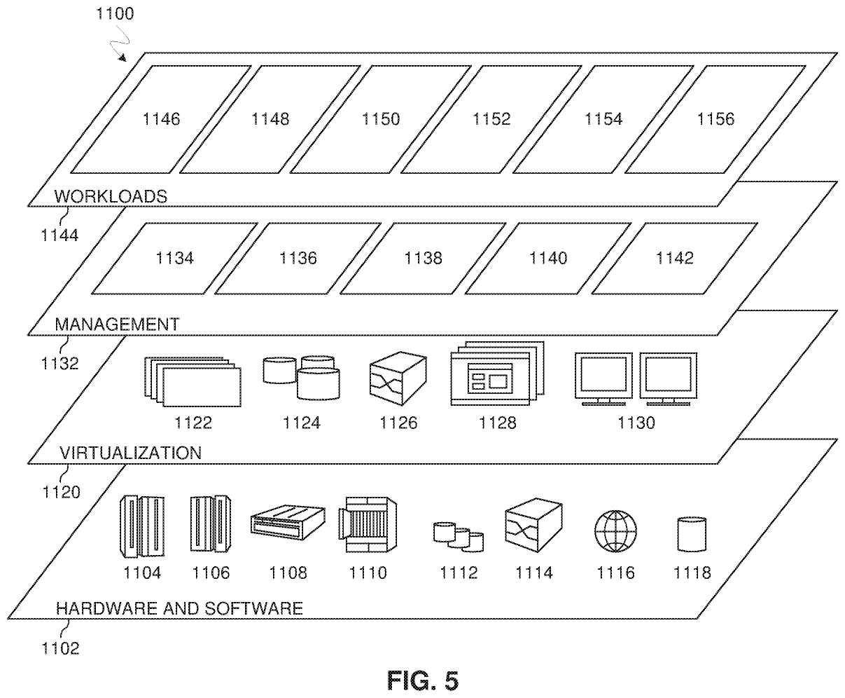

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and resource management 1156. A resource availability prediction program 110a, 110b implemented for the resource management 1156 provides a way to give improved wait estimates to individuals seeking to obtain a resource at a venue in which the demand exceeds the available space.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for resource management, the method comprising:
capturing, for each location of a venue, a respective first image of at least one resource being consumed;
capturing, for each location of the venue, a respective second image of the at least one resource being consumed;
comparing, via a computer system, the respective first image to the respective second image to produce a respective location wait time for each location of the venue, wherein the respective location wait time indicates an estimated duration until the respective location will become vacated and projects that the respective location will become vacated when consumption of the at least one resource at the respective location is finished;
determining, via the computer system, a soonest wait time from the location wait times; and
presenting the soonest wait time.

2. The method of claim 1, wherein the first images include a first party who is consuming the respective at least one resource;
wherein the second images include the first party; and
wherein the estimated duration estimates when the respective location becomes vacated by the first party leaving the respective location.

3. The method of claim 1, wherein at least one set of the first images and the second images further includes a first group of people at a first location of the respective locations;
wherein, of the first group of people, multiple people are consuming a respective resource at a respective capture time of the first image and of the second image;
wherein, of the respective resources, finishing of the consumption of the first resource occurs later than finishing of consumption of other resources; and
wherein the estimated duration projects that the first location will become vacated when the first group leaves the first location as a group.

4. The method of claim 3, wherein the first group of people is identified using a first machine learning model.

5. The method of claim 1, further comprising:
confirming that a full amount of the first resource has been provided to a first location;
wherein the capturing of at least one of the first image and the second image at the first location occurs in response to the confirming.

6. The method of claim 5, wherein the confirming occurs via capturing a confirmation image of the first location.

7. The method of claim 1, further comprising receiving a first order for the first resource; and
confirming that the first resource has been provided to a first location in correspondence to the first order;
wherein the capturing of at least one of the first image and the second image at the first location occurs in response to the confirming.

8. The method of claim 7, wherein the confirming occurs via capturing a confirmation image of the first location and comparing the confirmation image to the first order.

9. A computer system for resource management, the computer system comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
capturing, for each location of a venue, a respective first image of at least one resource being consumed;
capturing, for each location of the venue, a respective second image of the at least one resource being consumed;
comparing the respective first image to the respective second image to produce a respective location wait time for each location of the venue, wherein the respective location wait time indicates an estimated duration until the respective location will become vacated and projects that the respective location will become vacated when consumption of the at least one resource at the respective location is finished;
determining, via the computer system, a soonest wait time from the location wait times; and
presenting the soonest wait time.

10. The computer system of claim 9, wherein the first images include a first party who is consuming the respective at least one resource;
wherein the second images include the first party; and
wherein the estimated duration estimates when the respective location becomes vacated by the first party leaving the respective location.

11. The computer system of claim 9, wherein at least one set of the first images and the second images further includes a first group of people at a first location of the respective locations;
wherein, of the first group of people, multiple people are consuming a respective resource at a respective capture time of the first image and of the second image;
wherein, of the respective resources, finishing of the consumption of the first resource occurs later than finishing of consumption of other resources; and
wherein the estimated duration projects that the first location will become vacated when the first group leaves the first location as a group.

12. The computer system of claim 11, wherein the first group of people is identified using a first machine learning model.

13. The computer system of claim 9, wherein the method further comprises confirming that a full amount of the first resource has been provided to a first location;
wherein the capturing of at least one of the first image and the second image at the first location occurs in response to the confirming.

14. The computer system of claim 13, wherein the confirming occurs via capturing a confirmation image of the first location.

15. The computer system of claim 9, wherein the method further comprises receiving a first order for the first resource; and
confirming that the first resource has been provided to a first location in correspondence to the first order;
wherein the capturing of at least one of the first image and the second image at the first location occurs in response to the confirming.

16. The computer system of claim 15, wherein the confirming occurs via capturing a confirmation image of the first location and comparing the confirmation image to the first order.

17. A computer program product for resource management, the computer program product comprising a computer-readable storage medium having program instructions embodied therewith, wherein the program instructions are executable by a computer system to cause the computer system to perform a method comprising:
capturing, for each location of a venue, a respective first image of at least one resource being consumed;
capturing, for each location of the venue, a respective second image of the at least one resource being consumed;
comparing the respective first image to the respective second image to produce a respective location wait time for each location of the venue, wherein the respective location wait time indicates an estimated duration until the respective location will become vacated and projects that the respective location will become vacated when consumption of the at least one resource at the respective location is finished;
determining, via the computer system, a soonest wait time from the location wait times; and
presenting the soonest wait time.

18. The computer program product of claim 17, wherein the first images include a first party who is consuming the respective at least one resource;
wherein the second images include the first party; and
wherein the estimated duration estimates when the respective location becomes vacated by the first party leaving the respective location.

19. The computer program product of claim 17, wherein at least one set of the first images and the second images further includes a first group of people at a first location of the respective locations;
wherein, of the first group of people, multiple people are consuming a respective resource at a respective capture time of the first image and of the second image;
wherein, of the respective resources, finishing of the consumption of the first resource occurs later than finishing of consumption of other resources; and
wherein the estimated duration projects that the first location will become vacated when the first group leaves the first location as a group.

20. The computer program product of claim 19, wherein the first group of people is identified using a first machine learning model.
